(19) United States
(12) Patent Application Publication
(10) Pub. No.: US 2011/0258908 A1
(43) Pub. Date: Oct. 27, 2011

(54) LIQUID BAIT STATION AND PLUG THEREFOR

(75) Inventors: Yan Zhou, Santa Clara, CA (US); Daniel L. Walters, San Leandro, CA (US)

(73) Assignee: Central Garden & Pet Company, Walnut Creek, CA (US)

(21) Appl. No.: 12/766,166

(22) Filed: Apr. 23, 2010

(51) Int. Cl. A01M 1/20; A01M 25/00

(52) U.S. Cl. 43/131

(57) ABSTRACT

An insect bait station including a housing forming cavity for holding a liquid insect bait. The housing includes a main chamber, at least two reservoir chambers fluidly connected to the main chamber, and a bait station entrance. The entrance has a downwardly-positioned continuous wall leading from an opening in a top of the main chamber to an interior opening in an interior of the main chamber. A plug is provided for removably sealing the bait station. Various aspects of the bait station are directed to resisting spills and leaks after activation.

### BACKGROUND OF THE INVENTION

1. Field of the Invention

This invention relates, in general, to a device for controlling insects and pests and more particularly to insect bait stations.

2. Description of Related Art

Various types of devices have been developed for destroying or controlling insects in both indoor and outdoor applications. In some devices, the insects are trapped in the device after entering, either by mechanical construction or by sticking to a gummy substance. Other devices contain poison for killing insects on contact. Such devices have limited application because the device quickly becomes full and useless. In devices containing a poison, it often is easy to shake out loose poison or access the poison through openings, thus making them a danger to children or small domestic animals.

An exemplar of the prior art is U.S. Pat. No. 6,216,384 to Dickson et al. which shows a spill resistant bait station. The Dickson bait station includes an outer wall leading from a bottom surface up to an upper annular surface having a central axial recessed opening therein leading down to a bait source contained in the interior of the station. The bait station is configured to provide for flooding or concentration of the insect bait at a bottom of the station interior. Insects climb the outer wall and enter the station to retrieve the bait and then exit the station carrying bait back to the insect habitat. The Dickson bait station has a small opening to limit access to the insect bait, but the insect bait may easily spill out of the station if the bait station is tipped at extreme angles or flipped upside down such as when accidentally kicked or bumped. Moreover, the Dickson bait station makes use of granular insect bait which may be less effective than modern liquid formulations.

U.S. Pat. No. 7,310,908 to Bernard et al. shows an insect bait station with liquid insect bait. The bait station is formed as a sealed container including first and second concentric chambers in fluid communication for containing the bait. A user cuts a top portion off of the first chamber using scissors or a knife to provide access to the bait. A top cover is further disclosed for shielding the bait station opening while providing access. The Bernard bait station may provide for easy user activation but also be prone to spills and leakage.

U.S. Pat. No. 6,532,696 to Clark, III et al. discloses an insect bait station with a holder configured to provide a plurality of cavities and channels including a ramp leading from an entrance to a staging area and a holding area separated from the ramp. The fluid bait flows from the holding area to the staging area by gravity. The Clark bait station is meant to be rested on a solid, horizontal surface after activation. The station is highly susceptible to spills and leaks because even a small tilt may allow the fluid to run over the ramp and out the entrance.

The above and other conventional bait stations generally provide sufficient sealing of the bait during shipping but suffer from the inability to activate the bait station easily. While some bait stations claim to be spill-resistant, the above bait stations only resist spills and leaks through a limited range of motion, in particular at acute angles from a flat surface. Such bait stations are highly prone to spills and leaks if accidentally kicked or knocked over.

It is therefore desirable to provide an insect bait station which overcomes the above and other problems. It is desirable to provide an insect bait station which safely houses an insect bait, including liquid insect bait, during shipping and transport. It is desirable to provide a bait station that is substantially spill-proof and attractive to feeding insects. It is desirable to provide an insect feeding station that reduces the risk to children and pets.

It is desirable to provide a liquid insect bait station that is securely sealed during storage, shipping, and transit, and is readily activated by a user. It is desirable to provide an insect bait station that can be easily activated with reduced mess, minimal or no use of tools, and reduced potential exposure to the insect bait.

It is desirable to provide an insect bait station in which it is readily possible to detect the use and availability of the bait.

### BRIEF SUMMARY OF THE INVENTION

In summary, one aspect of the present invention is directed to an insect bait station including a housing forming cavity for holding a liquid insect bait, the housing having a main chamber and at least two reservoir chambers fluidly connected to the main chamber, and a bait station entrance, the entrance having a downwardly-positioned wall leading from an opening in a top of the main chamber to an interior opening in an interior of the main chamber.

The main chamber and the reservoir chambers may be elliptic cylinder-shaped. The reservoir chambers may be taller than the main chamber thereby forming upper recesses above and to the sides of the main chamber.

A volume above the lower opening may be greater than a volume below. The bait station may be dimensioned and configured to prevent liquid bait loaded in the housing from spilling out of the bait station entrance.

The bait station entrance may lead from an upper annular surface in the top of the main chamber to a lower annular surface. The bait station entrance may have an inverted frustoconical shape. The insect bait station may have a plug configured to removably seal the bait station entrance. The plug may have a shoulder configured to cooperate with the bait station entrance to provide a stop to insertion therein. The plug may have a gripping shaft that extends above the bait station entrance. A top of the gripping shaft may be below a top of each of the reservoir chambers.

The main chamber and reservoir chambers may be monolithically-formed. The insect bait station may further include a base affixed to a bottom of the housing to enclose the cavity. The base may be heat sealed to the housing.

The housing may be formed of transparent PVC.

Another aspect of the present invention is directed to an insect bait station assembly including a housing forming a cavity for holding liquid insect bait and having a main chamber, at least two reservoir chambers fluidly connected to the main chamber and positioned at ends thereof, and a bait station entrance. The entrance may have a downwardly-positioned wall leading from an opening in a top of the main chamber to an opening in an interior of the main chamber. Liquid insect bait may be housed within the cavity of the bait station, and a plug may be positioned in the bait station entrance and configured to removably seal the liquid bait inside the bait station.

Liquid insect bait may be filled to a level below the bait station entrance opening in the interior of the main chamber. The reservoir chambers may be dimensioned and configured to retain the liquid insect bait when the bait station may be at an angle thereby reducing the risk of spillage from the bait station entrance when the plug is removed. The plug may be removably sealed in the bait station entrance by interference fit. The plug may be formed of silicone rubber.

Various aspects of the present invention are directed to an insect bait system including an insect bait station and a liquid bait loaded in the housing. The insect bait station includes a housing and an opening in the housing providing access to an interior of the housing. The opening is dimensioned and configured based on the properties of the liquid bait to substantially reduce spilling of the liquid bait from the bait station. The liquid bait properties and opening may be correlated to substantially reduce spilling.

In various embodiments, the liquid bait includes a sugar-based attractant. In various embodiments, the liquid bait includes d-glucose. In various embodiments, the diameter of the opening is based on the physical properties of the liquid bait, and the diameter is sufficiently small to reduce spilling of the liquid bait therethrough.

The bait station assembly of the present invention(s) have other features and advantages which will be apparent from or are set forth in more detail in the accompanying drawings, which are incorporated in and form a part of this specification, and the following Detailed Description of the Invention, which together serve to explain the principles of the present invention(s).

### BRIEF DESCRIPTION OF THE DRAWINGS

FIG. 1 is a perspective view of bait station assembly in accordance with the present invention.

FIG. 2 is a front view of the bait station assembly of FIG. 1, illustrating the plug fully inserted in the bait station.

FIG. 3 is a side view of the bait station assembly of FIG. 1.

FIG. 4 is an exploded view of the bait station assembly of FIG. 1, illustrating the plug removed to activate the bait station.

FIG. 5 is a top view of the bait station of FIG. 1, illustrating the bait station with the plug removed.

FIG. 6 is a perspective view of the bait station of FIG. 5 with the plug removed.

FIG. 7 is a bottom perspective view of the bait station of FIG. 5, illustrating the base sealed to a bottom of the housing.

FIG. 8 is a front view of the bait station of FIG. 5, illustrating the station loaded with insect bait.

FIG. 9 is a side view of the bait station of FIG. 5, illustrating the station loaded with insect bait.

FIG. 10 is a front view of the bait station of FIG. 5, illustrating the insect bait below the interior opening when the station is tilted at an angle.

FIG. 11 is a front view of the bait station of FIG. 5, illustrating the insect bait below the interior opening when the station is positioned upside down.

FIG. 12 is a front view of the bait station of FIG. 5, illustrating the insect bait below the interior opening when the station tilted at an angle upside down.

FIG. 13 is a perspective view of the bait station of FIG. 1, illustrating ants entering the bait station entrance after activation in accordance with the present invention.

### DETAILED DESCRIPTION OF THE INVENTION

Reference will now be made in detail to the various embodiments of the invention, examples of which are illustrated in the accompanying drawings. While the invention will be described in conjunction with the various embodiments, it will be understood that they are not intended to limit the invention to those embodiments. On the contrary, the invention is intended to cover alternatives, modifications and equivalents, which may be included within the spirit and scope of the invention as defined by the appended claims

The present invention relates to devices for controlling or destroying insects. Various aspects of the invention relate to insect bait stations for administering poison to insects whereby insects remove material containing the poison from the station and carry the material back to the insect habitat for feeding of other insects thereby killing other insects. Various aspects of the invention relate to insect bait stations and bait for killing insects upon consumption.

Various aspects of the present invention relate to a spill-resistant or substantially spill-proof insect bait station configuration which minimizes the danger to children or domestic animals. In various respects “spill-resistant” and “substantially spill-proof” are used interchangeably. “Substantially spill-proof” refers to significantly preventing spills, but in some instances, a small amount of liquid may exit the station.

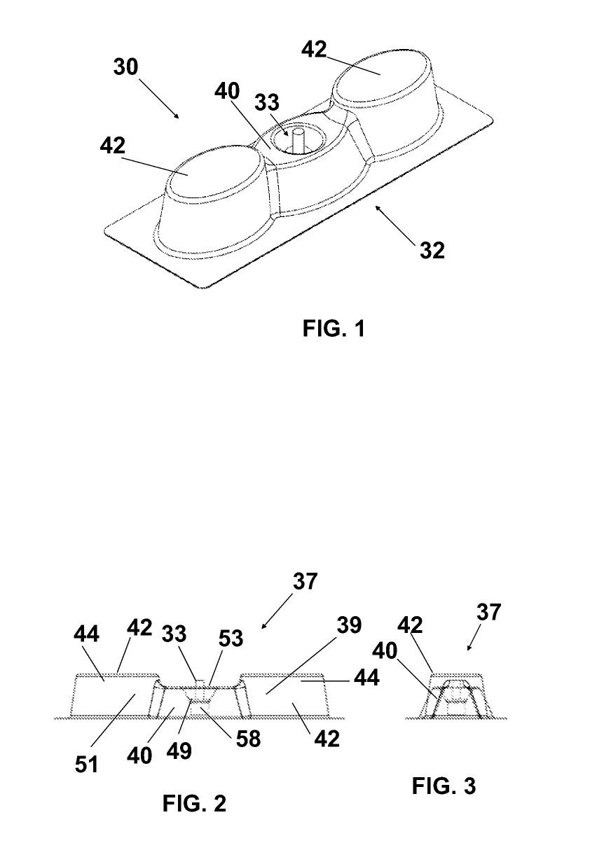

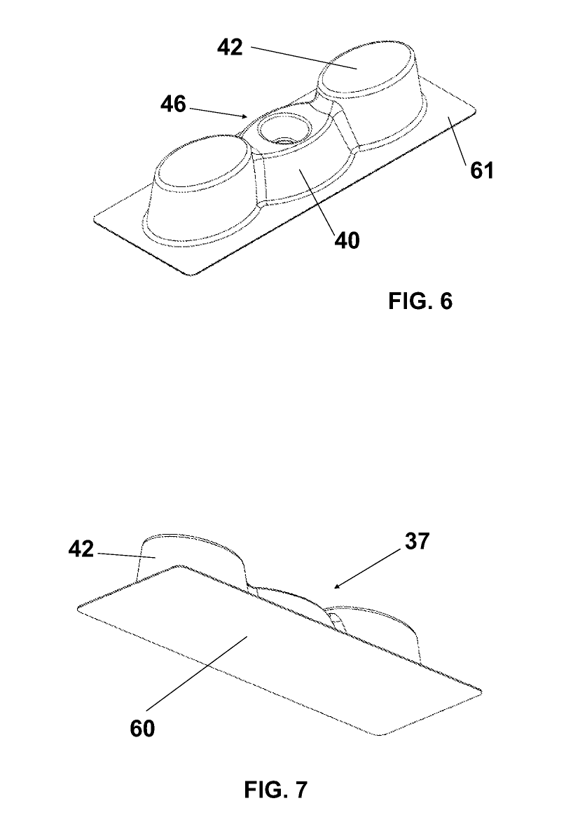

Turning now to the drawings, wherein like components are designated by like reference numerals throughout the various figures, attention is directed to FIGS. 1-8. In various embodiments, a bait station assembly, generally designated 30, includes a bait station 32, plug 33, and a flowable insect bait 35. The bait station includes a housing 37 forming a cavity 39 for holding the insect bait 35.

In various aspects, the insect bait is a liquid ant bait. The bait station may be used with a variety of known insect baits. Exemplars of an insect bait for killing ants are disclosed by U.S. Pat. No. 7,048,918 to Warner et al., U.S. Pat. No. 5,928,634 to Uick et al., and U.S. Pat. No. 5,939,061 to Vail et al. In various embodiments, liquid bait 35 is a composition including an attractant and a toxicant or poison. The attractant may be sugar-based, and preferably d-glucose. In various embodiments, the attractant is glucose, sucrose, dextrose, fructose, or a combination of the same. The attractant may include a food material attractive to the target insects, such as, but not limited to, flour, molasses, peanut butter, citrus pulp, animal fats such as lard and tallow, with an organic filler such as bran, and crushed puffed grain, pregel defatted corn cob grits or a starch matrix. Other additives can be added to the formulation, for example, dry pupa of silkworm, various animal digestive parts, such as freeze dried poultry liver, and the like. In various embodiments, the bait is a flowable liquid bait. In various embodiments, sodium tetraborate decahydrate is the active ingredient in the bait. In various embodiments, the active ingredient constitutes about 1% to about 10% by weight of the bait. In various embodiments, the active ingredient constitutes about 5.4% by weight of the bait. As used herein, “liquid” refers to flowable materials including, but not limited to, liquids and mixtures. Various aspects of the invention are directed to providing bait to insects that can be picked up by a foraging insect and carried back to the nest to be passed around to other insects. In this case, contact insecticides would not generally be suitable unless formulated as a slow-acting contact poison.

The bait station assembly in accordance with the present invention is useful for supplying bait to various types of insects and pests. In various embodiments, the bait station assembly is configured to control ants, such as, but not limited to, nuisance ants such as Pharaoh ants (Monomorium pharaohnis), odorous house ants (Tapinoma sessile), and acrobat ants (Crematogaster cerasi) and aggressive species such as the southern fire ant (Solenopsis xyloni), leaf cutting ants (Acromyrmex versicolor), Argentine ants (Iridomyrmex humilis), cornfield ants (Lasius alienus, pavement ants (Teiramorium caespitum), larger yellow ants (Acanothomyops interjectus), thief ants (Solenopsis molesta), and the red and black imported fire ants (Solenopsis invicta) and (Solenopsis saevissma richteri).

Housing 37 includes a main chamber 40 and reservoir chambers 42. In various embodiments, the housing is monolithically-formed and defines a generally open cavity. In various embodiments, the housing includes two or more reservoir chambers positioned around a periphery of the main chamber. In various embodiments, a pair of reservoir chambers are disposed at opposite ends of the main chamber. One will appreciate from the following description that the reservoir chambers may be located at various positions with respect to each other and the main chamber.

Reservoir chambers 42 and main chamber 40 are fluidly connected. In various embodiments, the reservoir chambers are physically open the main chamber. One will appreciate that the chambers may be fluidly connected by other suitable means such as through the use of fluid channels. In general, the fluid connection between the main chamber and reservoir chamber allows the fluid to be contained in the housing to flow from one chamber to another generally unimpeded.

Bait station 32 in accordance with the present invention is configured to reduce the risk of or prevent spilling of bait 35 from the interior. Exemplary housing 37 includes a main chamber and reservoir chambers formed as overlapping and coextensive spaces. Each of the chambers has a generally elliptical cylinder shape. In an exemplary embodiment, the main chamber has a major axis length of about 1⅛ inches and minor axis length of about ¾ inch. The reservoir chambers each have a major axis length of about 1⅜ inches and minor axis length of about ⅞ inch. Reservoir chambers 42 are taller than main chamber 40 such that recessed portions 44 are formed at the top of the reservoir chambers above the main chamber. In an exemplary embodiment, the reservoir chambers are each ¾ inch in height and the main chamber is ½ inch in height. The exemplary housing has a total volume of about 2 cubic-inches. One will appreciate from the description herein that the dimensions of the station may vary depending on various factors and parameters. In some applications, it may be desirable to provide a larger internal volume for holding more or larger bait or attracting larger insects and pests. For example, the exemplary bait station may have a larger volume by increasing the relative dimensions in order to provide for a longer-lasting bait supply.

Bait station 32 includes a bait station entrance 46 to allow insects and pests access to bait 35 in the station. The bait station entrance may be configured to allow the insects ingress and egress from the interior of the bait station so the insects can carry the bait back to their nest. The bait station entrance may also be configured to guide insects to the insect bait. In various embodiments, entrance 46 is formed as a hole in the top of main chamber 40 with a downwardly-positioned continuous wall 47 leading to a lower interior opening 49 in an interior 51 of housing 37. In various embodiments, bait station entrance 46 is frustoconically-shaped with an annular upper surface 53 having a centrally-located, recessed interior opening therein to cover the bait in the interior of the station. In various embodiments, the annular upper surface is a hole in a top of the main chamber formed with a beveled edge. As will be discussed in greater detail below, the recessed interior opening 49 reduces the risk of spillage when the bait station is flipped over.

Bait station assembly 30 includes plug 33 to fluidly seal bait station entrance 46 so the liquid bait is sealed inside the housing during transport. Because the liquid bait poses health and safety concerns, it is important for the liquid bait to be sealed in the housing without risk of spilling before the bait station is activated. In various embodiments, the plug and bait station entrance are configured to cooperate to ensure that fluid does not escape. In various embodiments, the plug seals the bait station sufficiently to withstand large pressure differentials. For example, if the bait station is shipped by air, the contents may be subjected to pressure differentials of about 10 psi. The bait station entrance may also be sealed by other means as would be understood by one of skill in the art from the foregoing.

In various embodiments, plug 33 is sealed to the bait station entrance by interference fit. The exemplary plug is formed of an elastomeric material that is chemically inert with the insect bait to be used. In various embodiments, the plug is formed of silicone rubber. The exemplary plug has a bottom configured to be inserted into bait station entrance 46 and plug interior opening 49. The bottom edge of the plug has a fillet to promote insertion into the opening. The exemplary interior opening 49 has a tapered, annular surface to guide the plug into the opening and aid in sealing of the plug. The lower end of the plug has a sealing surface for engaging the wall and edge of the opening. The sealing surface may be tubular with a substantially flat, annular wall to promote secure sealing to the opening.

The exemplary plug includes a shoulder 54 configured to abut the top of the bait station entrance and provide a positive stop to insertion of the plug. A gripping shaft 56 extends from a top of the plug to provide a surface for a user to grip the plug. In various embodiments, the gripping shaft extends above the bait station entrance. In various embodiments, a top of the gripping shaft is below a top of each of the reservoir chambers such that interference of the gripping shaft with the external environment is reduced. A bottom portion 58 of the plug extends through interior opening 49 and is exposed to the liquid ant bait. The elastomeric properties of the plug enable a tight seal once the plug is seated in the bait station entrance. One will appreciate, however, that other sealing means may be used such as, but not limited to, adhesive sealers, O-rings, and the like.

Conventional bait stations, such as those described by the above-mentioned Clark '696 patent, usually require cutting or breaking of the bait station to activate it. By contrast, bait station 32 is sealed by removable plug 33. The removable plug and bait station entrance of the present invention allow easier activation than conventional bait stations without the use of tools. In various embodiments, the bait station assembly is configured to be resealed. In an exemplary embodiment, the plug may be reinserted into the bait station entrance after initial removal for activation. The exemplary plug can be snapped out from the bait station entrance without the messes and spills inevitably associated with cutting.

Conventional bait stations generally involve cutting a bait station with scissors thereby contaminating the scissors with the liquid bait. A user must also discard the cut material, one side of which has been exposed to the liquid bait. Preliminary market research indicates that users greatly prefer the plug configuration of the present invention because users do not need to expose their fingers or scissors to any of the internal surfaces contaminated by the liquid ant bait. Instead, users grip gripping shaft 56 and the only portion of the plug exposed to the liquid bait—bottom portion 58—is separated from the user. Conventional bait stations also generally require cutting large holes in the bait station. Such large holes promote spilling of the liquid bait during use.

In various embodiments, the bait station entrance and liquid bait are configured such that the activated bait station is substantially spill-proof. In various embodiments, the opening is dimensioned and configured to reduce the ability of the liquid bait to flow therethrough based on the liquid characteristics. One will appreciate from the description herein how to adjust the opening size and shape based on the liquid bait characteristics to reduce the risk of spilling. In various embodiments, the liquid bait has a high surface tension such that it will cling to the bait station entrance walls and resist flowing through the opening. In various embodiments, the diameter of the opening in the bait station housing is sufficiently small to substantially prevent the loaded liquid bait from flowing therethrough. Fluids with higher viscosity and lower surface tension will consequently require a smaller diameter opening. The opening may also be configured and dimensioned based on the chemical properties of the liquid bait to reduce spilling. For example, electrostatic forces may be used to substantially prevent spilling of the liquid bait through the opening. One will appreciate from the description herein that the opening dimensions and configurations may reduce the risk of spillage alone or in combination with any of the other factors above.

The method of making the bait station assembly in accordance with the present invention will now be described. Housing 37 is formed by vacuum forming and shaping a sheet material to form cavity 39. A base 60 is applied over a bottom of the housing to seal the cavity thereby forming main chamber 40 and reservoir chambers 42 of the bait station. The base and housing are permanently sealed along a common edge thereby forming bait station 32. The base and housing may be joined by various techniques including, but not limited to, adhesives, ultrasonic welding, and heat welding. The exemplary bait station includes an optional flange section 61 to facilitate joining of housing 37 and base 60. One will appreciate that other forming and assembly techniques may be used to fabricate the bait station. For example, the housing and cavity may be injection molded in a single step.

After bait station 32 has been formed, the station is loaded with insect bait through bait station entrance 46. In various embodiments, the liquid insect bait is filled to a height of about 5/16 inch along the interior wall of the housing. The remainder of the housing volume may be filled with air or other materials. The housing may also be placed under a vacuum. Plug 33 is subsequently inserted into the bait station entrance to seal the insect bait inside the housing.

The bait station assembly may be formed of various materials. It may be important to select the housing and plug materials to be chemically inert with the insect bait. It may also be important to select materials that allow the targeted insect to crawl along the outer walls of the bait station. In various embodiments, the housing and base are formed from a thermoplastic polymer such as polyvinyl chloride (PVC) or polystyrene. In various embodiments, the plug is an elastomeric polymer such as silicone. In various embodiments, the liquid insect bait and housing are transparent such that the top of the base is viewable even when the station is loaded. The top of the base facing the interior of the housing may be lined with a label displaying the product name or other information. The label may be silk screened onto the base. In this way the label is visible from various angles through the housing. This has been found to be desirable for consumers because the label information is visible even when the station is activated and the underside of the base is hidden. The transparent construction also makes it easy for users to visibly determine how much insect bait is left or when bait station is full.

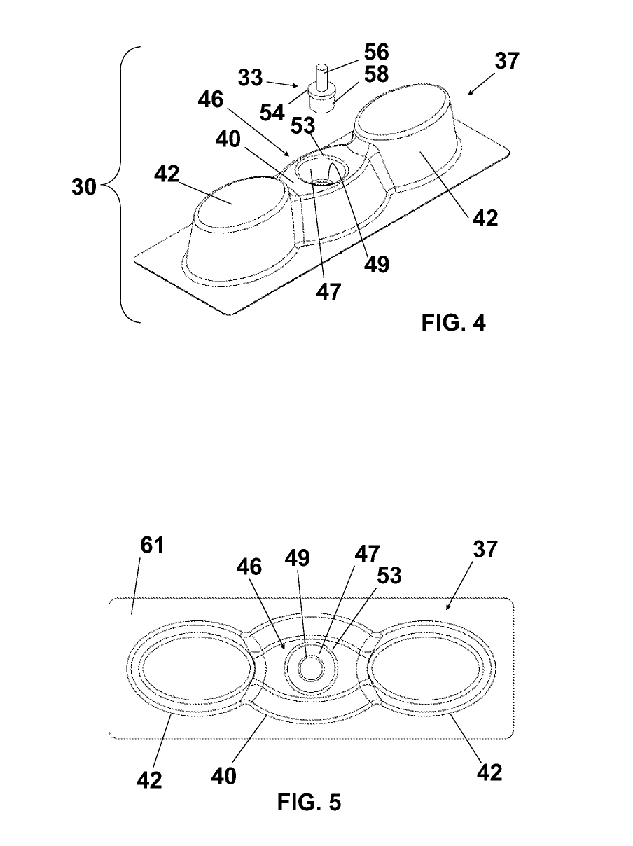

With particular reference to FIGS. 4 and 8-12, the bait station assembly in accordance with the present invention can be activated by pulling plug 33 from bait station entrance 46 thereby exposing insect bait 35 to the environment.

Although liquid bait has been found to have many advantages, it has been found that liquid bait stations have not been broadly adopted because consumers are concerned with the possibility of spilling the liquid ant bait. This is a particular concern where pets and young children may be near the bait station.

The bait station assembly in accordance with the present invention provides a substantially spill-proof solution to insect and pest control with liquid insect bait. When loaded with insect bait, the surface of the liquid insect bait remains below interior opening 49 of the bait station entrance. The combination of the housing shape and dimensions with the recessed interior opening enables significant reduction in the risk of spilling after activation by keeping the liquid bait away from the bait station interior opening. In various embodiments, the volume of space above the interior opening is greater than the volume below the interior opening. In various embodiments, reservoir chambers 42 have recesses 44 to accommodate the flowing liquid. In various embodiments, the reservoir chambers provide sufficient volume for fluid to collect when the bait station is tipped at an angle. As described above, the bait station entrance may also be dimensioned and configured based on the characteristics of the selected liquid bait to reduce or substantially prevent the liquid bait from spilling out.

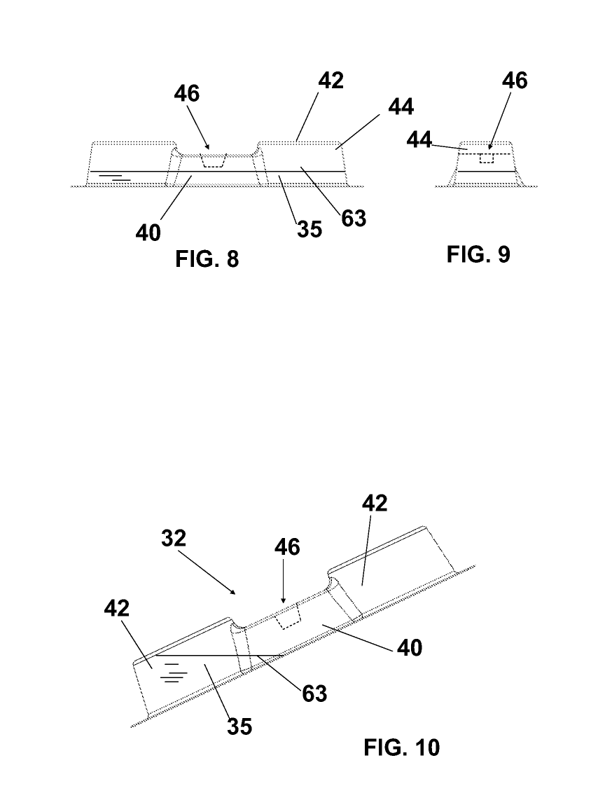

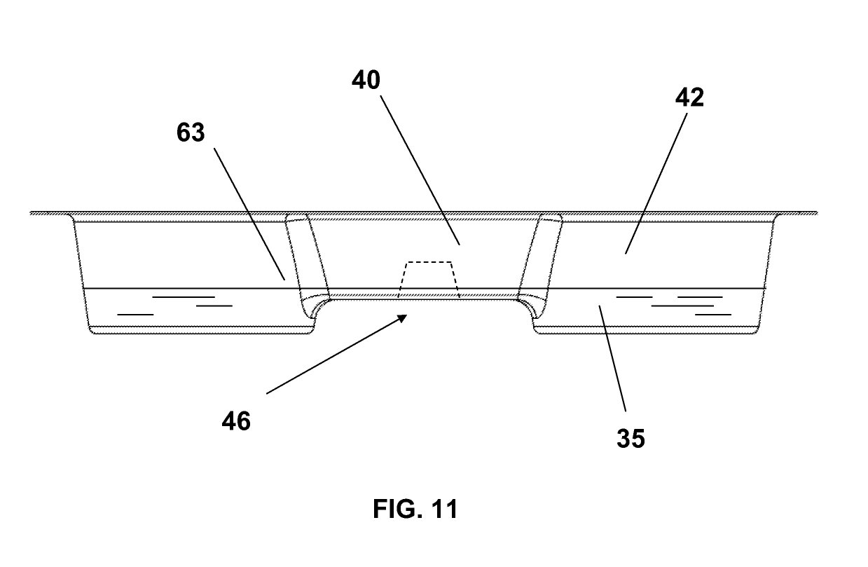

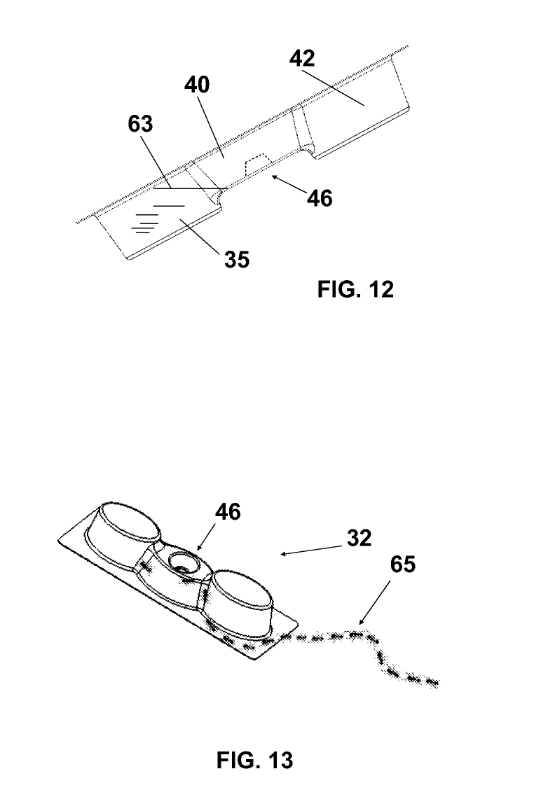

As shown in FIGS. 8-12, a surface 63 of the insect bait is below interior opening 49 at a variety of angles, even when the bait station is flipped over. As shown in FIG. 10, when the bait station is tilted at an angle, a respective reservoir chamber provides sufficient space for collecting the liquid insect bait such that the insect bait remains below the interior opening. In this manner, the reservoir chambers act similarly to auxiliary overflow chambers for directing flow away from the interior opening. As shown in FIGS. 11-12, the liquid insect bait remains below the interior opening even when the bait station is flipped upside down. One will appreciate from the description herein that the shape and dimensions of the housing—main chamber 40 and reservoir chambers 42—may vary while reducing the risk of spilling.

Once activated, bait station 30 may be placed on a surface accessible by the target insects. As illustrated in FIG. 13, insects 65 access the insect bait by crawling up a wall of the housing and into the bait station entrance. The insect bait is formulated to attract the insects and kill them upon consumption and/or contact. The bait may also be formulated to attract insects and begin killing them over time. Typically, the forager insects will be attracted to the insect bait first. In an exemplary embodiment, the liquid insect bait will begin attracting ants within about one to two days and remains effective for several weeks.

For convenience in explanation and accurate definition in the appended claims, the terms “up” or “upper”, “down” or “lower”, “inside” and “outside” are used to describe features of the present invention with reference to the positions of such features as displayed in the figures.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An insect bait station comprising:
a housing forming cavity for holding a liquid insect bait, the housing including:
a main chamber;
at least two reservoir chambers fluidly connected to the main chamber; and
a bait station entrance, the entrance having a downwardly-positioned wall leading from an opening in a top of the main chamber to an interior opening in an interior of the main chamber.

2. The insect bait station according to claim 1, wherein the main chamber and at least two reservoir chambers are elliptic cylinder-shaped.

3. The insect bait station according to claim 1, wherein the reservoir chambers are taller than the main chamber thereby forming upper recesses above and to the sides of the main chamber.

4. The insect bait station according to claim 1, wherein a volume above the lower opening is greater than a volume below.

5. The insect bait station according to claim 4, wherein the bait station is dimensioned and configured to substantially prevent a liquid bait loaded in the housing from spilling out of the bait station entrance.

6. The insect bait station according to claim 1, wherein the bait station entrance leads from an upper annular surface in the top of the main chamber to a lower annular surface.

7. The insect bait station according to claim 6, wherein the bait station entrance has an inverted frustoconical shape.

8. The insect bait station according to claim 7 in combination with a plug, the plug configured to removably seal the bait station entrance.

9. The insect bait station according to claim 8, wherein the plug includes a shoulder configured to cooperate with the bait station entrance to provide a stop to insertion therein.

10. The insect bait station according to claim 8, wherein the plug includes a gripping shaft that extends above the bait station entrance.

11. The insect bait station according to claim 10, wherein a top of the gripping shaft is below a top of each of the reservoir chambers.

12. The insect bait station according to claim 1, wherein the main chamber and reservoir chambers are monolithically-formed.

13. The insect bait station according to claim 12, further comprising a base affixed to a bottom of the housing to enclose the cavity.

14. The insect bait station according to claim 13, wherein the base is heat sealed to the housing.

15. An insect bait station assembly comprising:
a housing forming a cavity for holding a liquid insect bait, the housing including:
a main chamber; and
at least two reservoir chambers fluidly connected to the main chamber and positioned at ends thereof; and
a bait station entrance, the entrance having a downwardly-positioned continuous wall leading from an opening in a top of the main chamber to an opening in an interior of the main chamber;
a liquid insect bait housed within the cavity of the housing; and
a plug positioned in the bait station entrance and configured to removably seal the liquid bait inside the bait station.

16. The insect bait station assembly according to claim 15, wherein liquid insect bait is filled to a level below the bait station entrance opening in the interior of the main chamber.

17. The insect bait station assembly according to claim 15, wherein the reservoir chambers are dimensioned and configured to retain the liquid insect bait when the bait station is at an angle thereby reducing the risk of spillage from the bait station entrance when the plug is removed.

18. The insect bait according to claim 15, wherein the plug is removably sealed in the bait station entrance by interference fit.

19. The insect bait station according to claim 18, wherein the plug is formed of silicone rubber.

20. The insect bait according to claim 15, wherein the plug sufficiently seals the bait station to withstand a pressure differential during air transportation.

21. An insect bait system comprising:
an insect bait station including a housing and an opening in the housing providing access to an interior of the housing; and
a liquid bait loaded in the housing;
wherein the opening is dimensioned and configured based on the properties of the liquid bait to substantially reduce spilling of the liquid bait from the bait station.

22. The insect bait system according to claim 21, the housing comprising a main chamber and at least two reservoir chambers fluidly connected to the main chamber, wherein the reservoir chambers are taller than the main chamber thereby forming upper recesses above and to the sides of the main chamber.

23. The insect bait system according to claim 21, the opening being positioned in the upper wall of the housing and including a downwardly-positioned wall leading from the opening to an interior opening in the housing interior.

24. The insect bait system according to claim 21, wherein the liquid bait includes a sugar-based attractant.

25. The insect bait system according to claim 24, wherein the diameter of the opening is based on the physical properties of the liquid bait, the diameter being sufficiently small to reduce spilling of the liquid bait therethrough.
